(19) United States
(12) Patent Application Publication
(10) Pub. No.: US 2003/0120970 A1
(43) Pub. Date: Jun. 26, 2003

(54) Method and apparatus for debugging an electronic product using an internal I/O port

(76) Inventor: Chih-Yung Chen, Hsinchu (TW)

Correspondence Address: PEARNE & GORDON LLP, 526 SUPERIOR AVENUE EAST, SUITE 1200, CLEVELAND, OH, 44114-1484, US

(21) Appl. No.: 10/264,668

(22) Filed: Oct. 4, 2002

(30) Foreign Application Priority Data
Dec. 24, 2001 (TW) 090131960

(51) Int. Cl. H04L 1/22

(52) U.S. Cl. 714/25

(57) ABSTRACT

A method for debugging an electronic product using the internal I/O port and related apparatus uses an in-circuit emulator (ICE) and a switching means. The ICE is permanently installed in an electronic product and electronically connected to the internal input and output (I/O) ports and the processor in the electronic product. The switching means is used to switch the processor from the normal operation mode to the debug mode, enabling the ICE processor to take over control. A computer is connected to the electronic product through the internal I/O port. Through a special debug program executed from the computer, the switching means enables the ICE to carrying out the debugging/testing procedure or remote debugging, downloading or updating firm-ware. This method obviates the precarious connection to an external ICE or the designing of a special interface card for interconnecting the ICE.

### BACKGROUND OF THE INVENTION

### Field of the Invention

The present invention relates to a method for debugging an electronic product through the internal input/output (I/O) port and related apparatus, especially to a method of using the internal I/O port of the electronic product to connect to a computer, through which a special test program switches the internal processor to the debugging/testing mode.

Thanks to tremendous developments in software technology, many computer peripherals and home appliances have been equipped with an internal processor to provide add-on capabilities. There are many types of processors available on the market to suit the various user needs, with respect to the processor operation, circuit design and programming portion. Besides choosing the hardware, users can also input specific program instructions to the firmware to cause the processor to perform specific operations.

During the development of an electronic product, it is often necessary to rely on debugging and testing procedures to emulate all error situations and corrections. Even for commercial products, these procedures are a valuable tool for maintenance work. To meet the needs for the product development stage and the maintenance of a commercial product, an in-circuit emulator (ICE) is often used for debugging/testing. A number of conventional methods are known for performing the debugging/testing. These methods all involve an external ICE and an external connection either by means of special wiring or through a special connector.

(1) Special wiring allows an external ICE device to be connected through hard wires and connectors to the corresponding internal CPU I/O pins on the circuit board (such as PORT0, PORT2, ALE, PSEN, RESET, CLK etc). It also uses existing connectors on the circuit board to connect a computer, which then issues debugging/testing instructions. However, this method has some disadvantages. (1) The necessary wiring procedures can be rather complicated, and (2) the external casing of the electronic product has to be removed to make the wiring connections with the internal CPU and the circuit board. These processes are often quite inconvenient for normal users.

(2) A special connector is initially mounted on the circuit board of an electronic product. Whenever a debugging/testing procedure is to be performed, an ICE device is externally connected through the special connector to allow the ICE device to be electronically connected to the corresponding pins of the internal CPU. When this method is used, the special wiring process is obviated. However, the resultant manufacturing costs are higher, and the external casing still needs to be removed to access the special connector.

Both in the product development stage and in the maintenance of a commercialized product, existing electronic products with an internal processor as a control unit definitely need an external ICE device for debugging/testing. Considering the inconvenience to make the necessary wiring connections for debugging/testing, a better way needs to be found to perform debugging/testing.

### SUMMARY OF THE INVENTION

The main object of the present invention is to provide a method for debugging/testing an electronic product through the internal I/O port, and the related apparatus, without using an external ICE device.

The method mainly comprises the steps of interconnecting the internal processor of the electronic product with the internal I/O port and internal ICE and switching between a normal operation mode and debug mode with a switching means. In the debug mode, the ICE processor is connected to a computer through the I/O port of the product, through which a debug program in the internal ICE is invoked by the computer to perform the debugging/testing procedures. With such a design and procedure, the related costs can be reduced without having to use an external ICE device, and the inconvenience of making external connection to an ICE device can be obviated. Further connecting the foregoing computer to the Internet makes it possible to perform remote debugging and update the firmware through the Internet.

The switching means mentioned above is triggered by a break point or an external breakpoint, which disables the internal processor and switches to the debug mode to closely monitor the data transition in the internal registers in the debugging process.

The break point mentioned above is related to a specific address, data value and status generated in the processor. After distinguishing the specific address, data value and status that match the break point, the processor switches control to the ICE operation (debug) mode.

### BRIEF DESCRIPTION OF THE DRAWINGS

FIG. 1 is a system block diagram of a method and apparatus for debugging an electronic product through the internal input/output (I/O) port in accordance with the present invention;

FIG. 2 is a block diagram and flowchart of the interrupt signal generation process used in the method and apparatus in FIG. 1;

FIG. 3 is a block diagram of the apparatus for debugging an electronic product through the internal input/output (I/O) port in accordance with the present invention relative to the electronic product processor and ICE.

### DETAILED DESCRIPTION OF THE PREFERRED EMBODIMENT

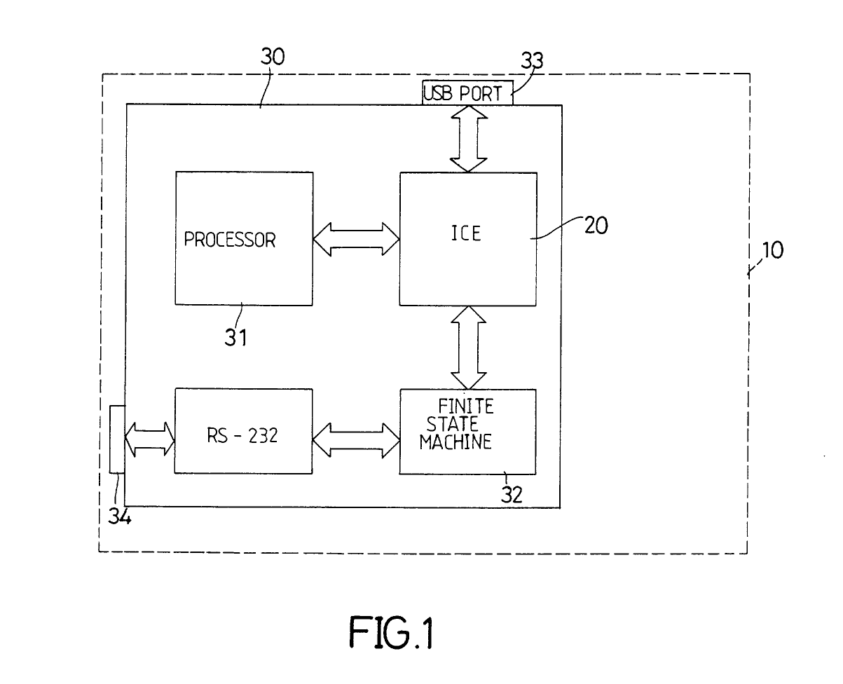

With reference to FIG. 1, an in-circuit emulator (ICE) (20) is permanently installed in an electronic product (10) that has an internal processor (31). In the present embodiment, the processor (31) is installed on a circuit board (30), together with a finite state machine (32) and an I/O port. The ICE device (20) interconnects the processor (31), the finite state machine (32) and a first I/O port (33). Alternatively, the ICE device (20) could interconnect a second I/O port (34). In the present embodiment, the first I/O port (33) is a universal serial bus (USB) and the second I/O port (34) is an RS-232. Under normal conditions, the USB port (33) is connected to a computer, but if the computer crashes, a second I/O port (34) could be used to connect another computer to continue the debugging process.

The ICE device (20) is OFF in the normal operation mode. When the computer starts to execute the debug program through the first I/O port (33), the operation of the processor is temporarily stopped to switch to the ICE operation mode. During the debugging/testing process, the data flow between the processor (31) and data registers can be observed through the ICE (20).

Assuming a scanner is the electronic product (10) in the normal operation mode, the scanner is connected to the computer through the first I/O port (33). The computer executes instructions to scan a document, and the scanner then returns the captured image signal to the computer. If the scanner breaks down, the computer could still execute the debug program and order the internal processor (31) of the scanner through an existing I/O port to stop the current operation temporarily. An internal ICE (20) in collaboration with a finite state machine (32) is activated to debug the internal data flow to and from the data registers. When the scanner is through with the debugging process, the ICE (20) is then disabled and the scanner automatically switches back to the normal operation mode.

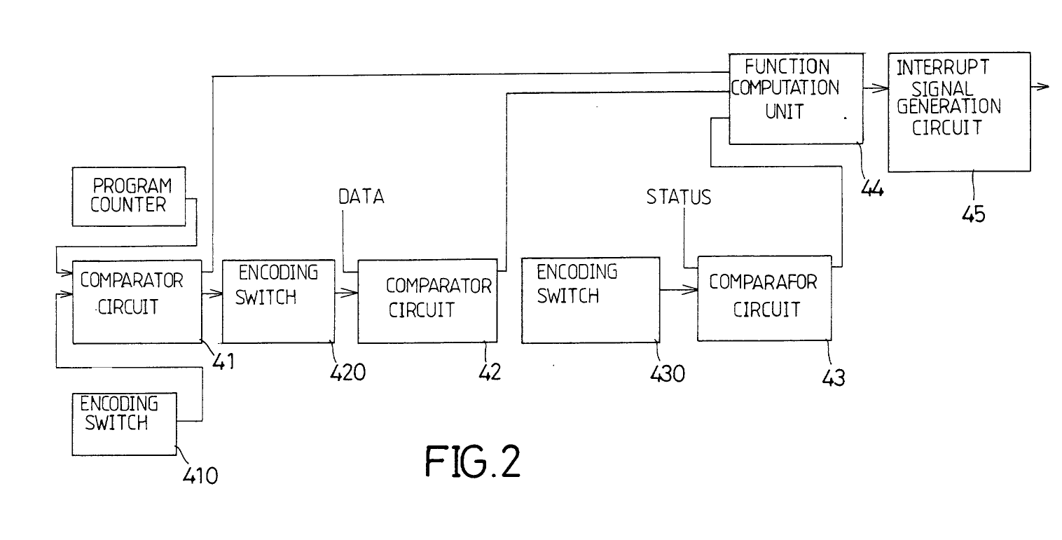

One way of activating the ICE (20) is to set up additional end points in the processor (31) of the electronic product, where the ICE device (20) issues orders to the processor (31) such as halt the operation, dump data and save the registers. With the USB interface as an example, a maximum of 16 endpoints could be set up in the processor, even though a few are needed for debugging. The increased end points will not affect the normal operation of the processor. Switching to the debug mode only requires that the debug program be invoked from the computer, and the product will be switched to the ICE operation mode automatically. Besides using end points as in this method, break points or check trace buffers can be used to accomplish the same task. The break point previously mentioned could be related to specific data or status at a specific address in the processor. When the processor distinguishes the address, data value and status, it switches to the debug mode automatically. With additional reference to FIG. 2, an interrupt signal generator is used to determine an end point or break point previously mentioned, which comprises:

multiple sets of comparator circuits (41-43);

a function computation unit (44); and

an interrupt signal generation unit (45).

In the present embodiment, the reference signal terminal on each one of the comparator circuits (41˜43) is respectively connected to an encoding switch (410, 420, 430) to set the address, data or status necessary for switching the processor to the debug mode. An input of one of the comparator circuits (41) is connected to a program counter (PC), and the input of the other two comparator circuits (42, 43) are connected to the internal I/O port of the processor (31). The outputs of the comparator circuits (41˜43) are connected to the function computation unit (44). The output of the function computation unit (44) becomes the data output of the interrupt signal generation unit (45).

That is to say, when the program counter counts to the break point address, and the comparator circuits (42˜43) also detect the corresponding data or status, all three comparator circuits (41˜43) simultaneously output an interrupt signal to the function computation unit (44) to enable the function or logic operation, and generate a signal output to the interrupt signal generation unit (45). The interrupt signal generation unit (45) then outputs a signal to the processor (31) that halts the current operation and switches to the debug mode.

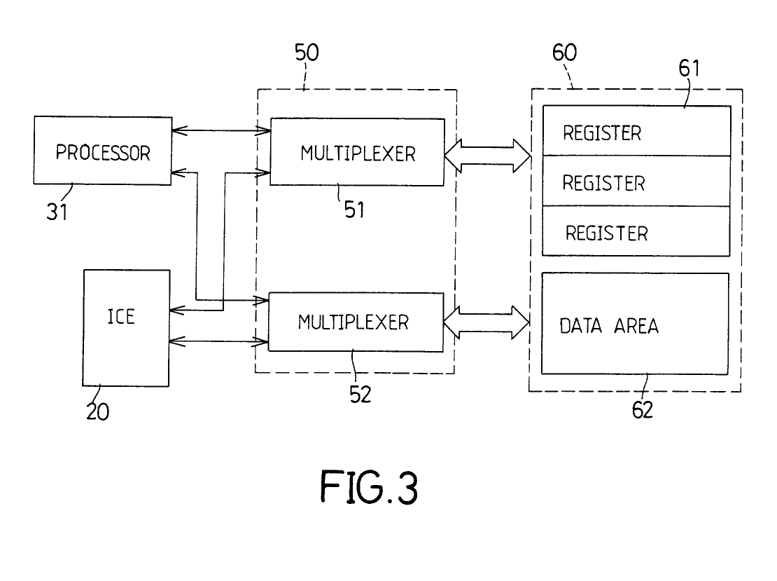

With additional reference to FIG. 3, a switching unit (50) is connected to the processor (31), ICE (20) and memory (60), wherein multiple registers (61) and multiple data areas (62) are located in the memory (60). The switching unit (50) is formed by two multiplexers (51, 52), whose select pins (S) are controlled by the signal output from the finite state machine (32) to switch between the processor (31) or ICE device (20). In the debug mode, these two multiplexers (51, 52) select to receive ICE (20) signals for retrieving/writing data from/to the memory corresponding to a specific address throughout the process of debugging/testing.

In the present invention, a computer loaded with the debug program is externally connected to an electronic product through the internal I/O port. However, if the electronic product is already connected to a computer, that computer can be used for the debugging/testing without changing the configuration. Performing network operations such as downloading or updating the processor firmware through a local area network, Internet, or remote server is possible, and remote debugging operation can also be carried out.

The present embodiment mainly makes use of an internal ICE for debugging/testing, in collaboration with a computer loaded with special purpose software. It is not necessary to use an external ICE device, open up the external case of the product, or install any special connectors to perform the debugging operation. Therefore, this method is more convenient and cost less to use than other conventional methods. The present invention is clearly advantageous on the merits of resource utilization and progressiveness.

The foregoing illustration of the preferred embodiments in the present invention is intended to be illustrative only, under no circumstances should the scope of the present invention be so restricted.

What is claimed is:

1. A method for debugging an electronic product through the internal I/O port, the steps comprising:
installing an ICE device permanently inside the electronic product;
interconnecting the internal processor, I/O port and internal ICE electronically; and
switching the electronic product between the first and second mode with a switching means; under the second mode, the computer executes a special program to switch control from the internal processor to the ICE processor through the internal I/O port to perform the debugging/testing procedures.

2. A method for debugging an electronic product through the internal I/O port as claimed in claim 1, wherein the first mode is the normal operation mode, and the second mode is the debug mode.

3. A method for debugging an electronic product through the internal I/O port as claimed in claim 1, wherein the switching means is controlled by the end point on the processor.

4. A method for debugging an electronic product through the internal I/O port as claimed in claim 1, wherein the processor operation is temporarily stopped by a break point or external break point, causing it to be switched to the second mode (the debug mode) for close observation of the data transition between the processor and internal registers in the debugging process.

5. A method for debugging an electronic product through the internal I/O port as claimed in claim 4, wherein the break point refers either to a given data or status at a specific address.

6. A method for debugging an electronic product through the internal I/O port as claimed in claim 1, wherein the electronic product can be connected through a second I/O port other than the first I/O port to another computer.

7. A method for debugging an electronic product through the internal I/O port as claimed in claim 1, wherein the first and internal I/O port is a USB port, where the second I/O port is an RS-232 port.

8. A method for debugging an electronic product through the internal I/O port as claimed in claim 6, wherein the first and internal I/O port is a USB port, where the second I/O port is an RS-232 port.

9. An apparatus using the internal I/O port for debugging, comprises: a processor installed on the circuit board of the electronic product, an in-circuit emulator (ICE) installed inside the electronic product and connected to the internal I/O port and processor electronically, and a finite state machine connected to the ICE electronically to control the operation mode of the ICE device.

10. An apparatus using the internal I/O port for debugging as claimed in claim 9, wherein the apparatus further comprises an interrupt signal generation unit connected to the processor to provide the interrupt signal for switching to the debug mode.

11. An apparatus using the internal I/O port for debugging as claimed in claim 10, wherein the interrupt signal generator includes: a comparator circuit, a function computation unit and an interrupt signal generation unit; wherein the reference signal terminal of the comparator circuit is electronically connected to an encoding switch to set the necessary address, data and status for switching to the debug mode, and the input of the first comparator circuit is connected to a program counter, and the input of the second and third comparator circuits are connected to the processor I/O port, and the output from the first to third comparator circuits are connected to the function computation unit, whose output signal becomes the data output of the interrupt signal generation unit.

12. An apparatus using the internal I/O port for debugging as claimed in claim 9, wherein the apparatus further comprises memory, with multiple registers and data areas, connected to the processor and ICE device.

13. An apparatus using the internal I/O port for debugging as claimed in claim 12, wherein the apparatus further comprises a switching unit interconnecting the memory, processor and ICE device.

14. An apparatus using the internal I/O port for debugging as claimed in claim 13, wherein the apparatus further comprises at least one multiplexer for interconnecting the memory, processor and ICE device.
